(19) United States
(12) Patent Application Publication
(10) Pub. No.: US 2006/0175525 A1
(43) Pub. Date: Aug. 10, 2006

(54) Protection arrangement for a hard disk

(75) Inventor: Jen-Jia Liou, Taipei City (TW)

Correspondence Address: BACON & THOMAS, PLLC, 625 SLATERS LANE, FOURTH FLOOR, ALEXANDRIA, VA, 22314, US

(73) Assignee: Tatung Company, Taipei City (TW)

(21) Appl. No.: 11/261,476

(22) Filed: Oct. 31, 2005

(30) Foreign Application Priority Data
Dec. 30, 2004 (TW) 093141408

(51) Int. Cl. F16M 13/00

(52) U.S. Cl. 248/615

(57) ABSTRACT

The present invention is related to a protection arrangement for a hard disk. The protection arrangement is positioned in the four corners of the hard disk; each corner of the hard disk having a right-angled triangular buffer piece. Each of buffer pieces is formed of elastic material, such as rubber. Each buffer piece has a top substrate, a base, a first side wall, and a second side wall; the top substrate, base, first side wall, and the second side wall together form a right-angled triangular recess with an opening and the right-angled triangular recess can be sleeved onto a respective right-angled triangular block of the hard disk to attain the purpose of stabilizing and protecting the hard disk.

### BACKGROUND OF THE INVENTION

1. Field of the Invention

The present invention relates to a protection arrangement used on a hard disk; and, more particularly, to a buffering protection cover to be used on a hard disk of a computer.

2. Description of Related Art

Prior hard disks are always set up with a protection cover on the external surface of the hard disk due to the fact that the internal disk experiences high-speed operations when the hard disk is in operation. If the disks collide during such operation, there will be damage to the disks. Therefore, it is required to effectively stabilize the disk to prevent it from sliding. The prior stabilizing technique of the hard disk simply uses an upper shock-absorbing cotton pad and a lower shock absorbing cotton pad to cover the whole hard disk. Alternatively, a shock-absorbing rubber mat can be used to cover the whole hard disk in an attempt to stabilize the disk. Despite those attempts, the prior techniques are unable to effectively stabilize the whole hard disk. Furthermore, these stabilizing techniques are difficult to apply in fabrication and also increase the expense. Therefore, the prior techniques have many drawbacks that require improvement.

Therefore, it is desirable to provide an improved protection arrangement for a hard disk to mitigate and/or obviate the aforementioned problems.

### SUMMARY OF THE INVENTION

The object of the present invention provides a protection arrangement to be sleeved onto an external surface of a hard disk, to attain the purpose of protecting the hard disk and at the same time stabilizing it.

To achieve the object, the present invention provides a protection arrangement for a hard disk. The hard disk comprises four corners, each of the corners having a right-angled triangular block. The protection arrangement comprises: at least one buffer piece, the buffer piece having a triangular recess, therein, the triangular recess sleeved onto the right-angled triangular block of the hard disk.

In the protection arrangement for a hard disk, the buffer piece comprises a top substrate, a base, a first sidewall, and a second sidewall; the top substrate, the base, the first sidewall and the second sidewall form a right-angled triangular recess with an opening. The top substrate of the buffering piece further has a wave-shaped protuberance.

In the protection arrangement for a hard disk, the quantity of the buffer pieces may be four; each right-angled triangular recess of the buffer piece is respectively sleeved onto one of the right-angled triangular blocks of the hard disk. The buffer pieces are identical in shape.

In the protection arrangement for a hard disk, the buffer piece is integrally formed from elastic rubber material in an integrated manner.

Furthermore, in the protection arrangement for a hard disk, wherein two symmetrical pairs of buffer pieces are respectively joined by two cross-bars.

In the protection arrangement for a hard disk, wherein the four buffer pieces are joined by three cross-bars to form a substantially U-shaped buffer frame with an opening.

### BRIEF DESCRIPTION OF THE DRAWINGS

FIG. 1 is a structural diagram of the buffer piece according to the present invention.

FIG. 2 is an exploded diagram of the buffer pieces and the hard disk.

FIG. 3 is a first exploded diagram of the protection arrangement for a hard disk configured into a multimedia player.

FIG. 4 is a second exploded diagram of the protection arrangement for a hard disk configured into a multimedia player.

FIG. 5 is a third exploded diagram of the protection arrangement for a hard disk configured into a multimedia player.

### DETAILED DESCRIPTION OF THE PREFERRED EMBODIMENT

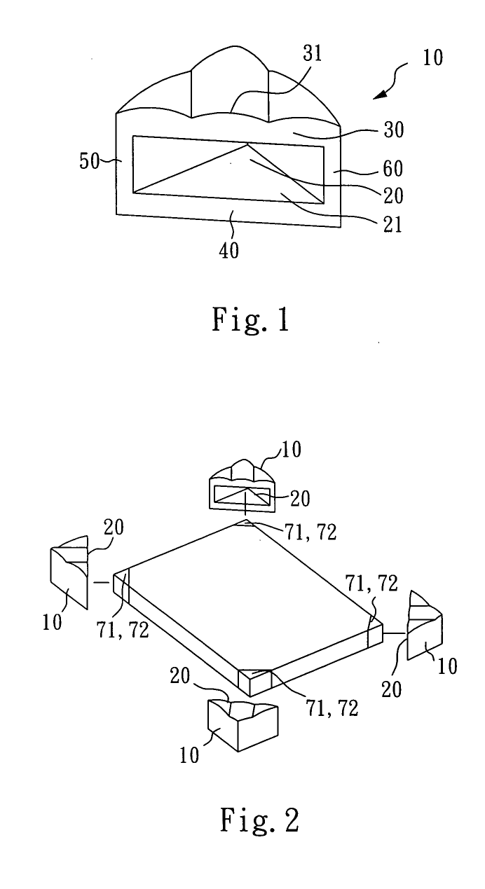

Referring to FIG. 1, a structural diagram of the buffering protector for a hard disk is shown. In the embodiment, the protection arrangement comprises a buffer piece 10 made of a resilient material such as rubber. The buffer piece 10 comprises a top substrate 30, a base 40, a first side wall 50, and a second side wall 60. In the embodiment, the top substrate 30, the base 40, the first side wall 50, and the second side wall 60 form a right-angled triangular recess 20 with an opening 21. The top substrate 30 of the buffer piece 10 includes a wave-shaped protuberance 31. The right-angled triangular recess 20 is sleeved onto the right-angled triangular block 72 of the hard disk, so as to fix and protect the hard disk against shock.

As shown in FIG. 2, the hard disk comprises four corners 71, and each of the comers 71 has a right-angled triangular block 72. The right-angled triangular recess 20 of the buffer piece 10 is sleeved onto the right-angled triangular block 72 of the hard disk 70. Four comers 71 of the hard disk 70 are respectively fitted with four of the buffer pieces 10.

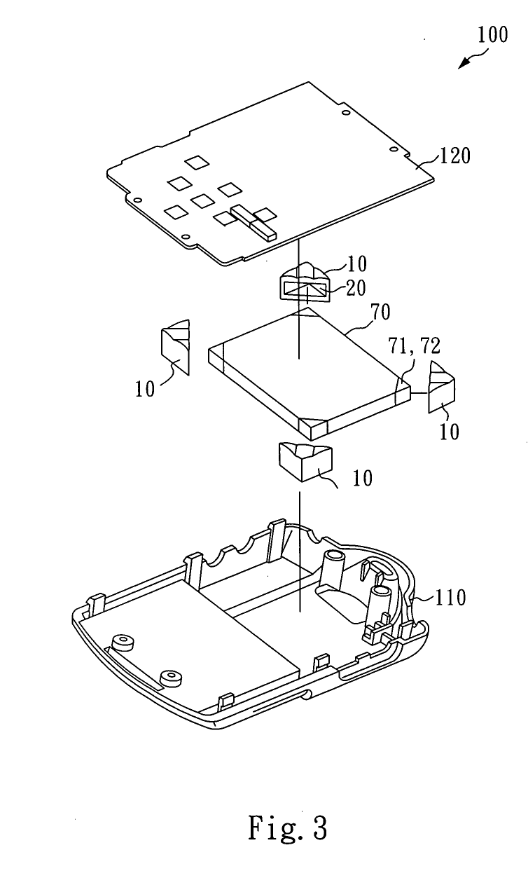

Referring to FIG. 3, the protection arrangement for a hard disk is configured into a multimedia player. The right-angled triangular recess 20 of each buffer piece 10 is sleeved onto the right-angled triangular block 72 of the hard disk 70. Moreover, the hard disk 70 is installed in the multimedia player. The multimedia player comprises a mainframe 110 and a case 120 where the hard disk 70 can be installed. The buffer piece 10 on the hard disk 70 coincides with the case 120, thus enabling the hard disk 70 to be more stable.

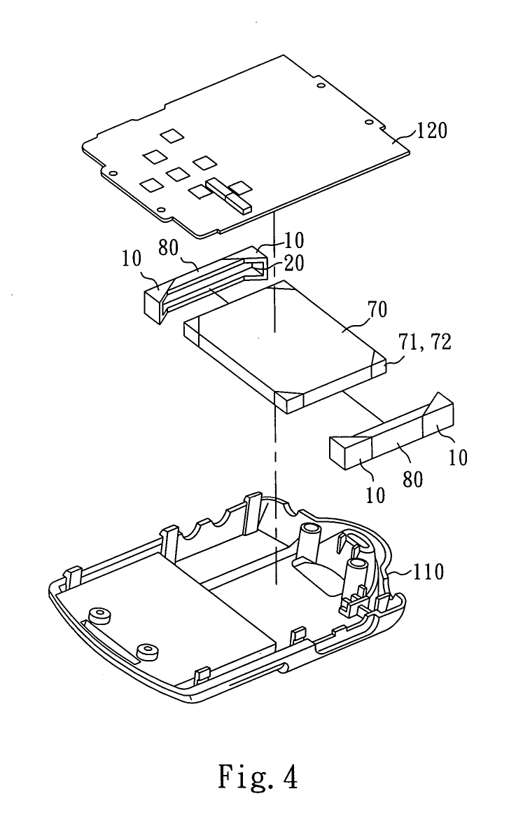

Referring to FIG. 4, a second embodiment shows the protection arrangement for a hard disk configured into a multimedia player. The right-angled triangular recess 20 of each buffer piece 10 is sleeved onto the right-angled triangular block 72 of the hard disk 70. That is, the piece cross-bar substantially U-shaped in cross-section 80 and defining a slot has two opposed, symmetrically shaped ends to respectively mate with two the buffer pieces 10, thereby forming a buffer strip. The two symmetrical pairs of buffer pieces are respectively joined by two cross-bars. The present invention using two symmetrical pairs of or four buffer joined by two or three cross-bars whereby additional protection is provided to the hard disk.

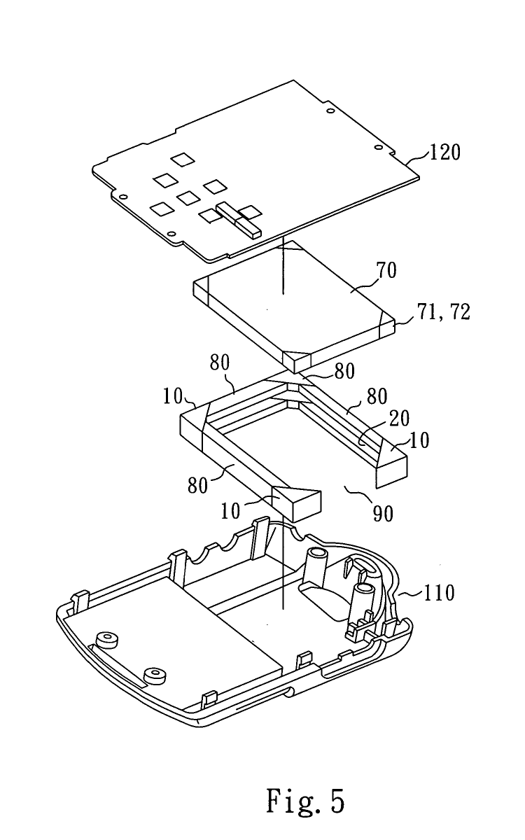

Referring to FIG. 5, a third embodiment comprises three of the cross-bars connecting four of the buffer pieces 10 to create a U-shaped combined buffer frame 10 with an open end leading to a reception area. As shown, the slots of the cross-bars align with each other and the buffer pieces 10 to allow the hard disk 70 to slide into the reception area, whereby additional protection is provided to the hard disk

Although the present invention has been explained in relation to its preferred embodiment, it is to be understood that many other possible modifications and variations can be made without departing from the spirit and scope of the invention as hereinafter claimed.

What is claimed is:

1. A protection arrangement for a hard disk, said hard disk comprising four corners, each of said corners having a right-angled triangular block, said protection arrangement comprising:
a buffer piece, said buffer piece having a triangular recess, therein, said triangular recess sleeved onto said right-angled triangular block of said hard disk.

2. The protection arrangement for a hard disk as claimed in claim 1, wherein said buffer piece comprising a top substrate, a base, a first side wall, and a second side wall; said top substrate, said base, said first side wall and said second side wall forming a right-angled triangular recess with an opening.

3. The protection arrangement for a hard disk as claimed in claim 2, wherein said top substrate of said buffer piece comprising a wave-shaped protuberance.

4. The protection arrangement for a hard disk as claimed in claim 1, wherein the quantity of said buffer piece is four; each right-angled triangular recess of said buffer pieces is respectively sleeved onto said right-angled triangular blocks of said hard disk.

5. The protection arrangement for a hard disk as claimed in claim 4, wherein said buffer pieces are identical in shape.

6. The protection arrangement for a hard disk as claimed in claim 1, wherein said buffer piece is made of a resilient material.

7. The protection arrangement for a hard disk as claimed in claim 1, wherein the two symmetrical pairs of buffer pieces are respectively joined by two cross-bars.

8. The protection arrangement for a hard disk as claimed in claim 1, wherein the four buffer pieces are joined by three cross-bars to form a substantially U-shaped buffer frame with an opening.
